(19) United States
(12) Patent Application Publication
(10) Pub. No.: US 2025/0233373 A1
(43) Pub. Date: Jul. 17, 2025

(54) BRANCH SYSTEM AND HOLDER MEMBER

(71) Applicant: HIROSE ELECTRIC CO., LTD., Kanagawa (JP)

(72) Inventors: Yoshiki YAMAGUCHI, Kanagawa (JP); Takahiro KIKUCHI, Kanagawa (JP)

(21) Appl. No.: 18/988,167

(22) Filed: Dec. 19, 2024

(30) Foreign Application Priority Data
Jan. 15, 2024 (JP) 2024-003851

(51) Int. Cl. H01R 13/684; H01H 85/045

(52) U.S. Cl. CPC H01R 13/684; H01H 85/045

(57) ABSTRACT

Provided is a branch system which includes a power connector attachable to a power supply line; and a branch connector attachable to a branch wire and connectable to the power connector in an attachable and detachable manner, in which the branch connector includes a glass tube fuse, and a first holding portion; the first holding portion is configured to hold the glass tube fuse in an attachable and detachable manner or in a fixed state; and the power supply line and the branch wire are configured to establish an electrical connection through a fusing portion of the glass tube fuse held by the first holding portion upon the branch connector being connected to the power connector.

### CROSS-REFERENCE TO RELATED APPLICATION

This application claims priority from Japanese Patent Application No. 2024-003851 filed with the Japan Patent Office on Jan. 15, 2024, the entire content of which is hereby incorporated by reference.

### BACKGROUND

### 1. Technical Field

The present disclosure relates to a branch system and a holder member.

### 2. Related Art

A branch system that uses a fuse is known (refer to, for example, JP-A-9-63457). The branch system of JP-A-9-63457 includes a fuse connector that is used by being pressure welded to a power supply line, and a female connector that is mated to the fuse connector. A female terminal connected to a branch wire is housed in the female connector. It is configured in such a manner that the female connector is mated to the fuse connector, and as a result, the female terminal of the female connector is mated to a connector terminal of the fuse connector, which is a male terminal. Moreover, the fuse connector is provided with a fuse including a pair of fuse terminals, in a state of the fuse being inserted in a fuse fitting portion. The fuse connector includes a housing, a joint terminal, and a pressure welding terminal. In the joint terminal, a fuse terminal mating portion and a plurality of connector terminals are integrally formed. In the pressure welding terminal, a pressure welding blade and a fuse terminal mating portion are integrally formed. It is configured in such a manner that one of the pair of fuse terminals is inserted into the fuse terminal mating portion of the joint terminal, and the other is inserted into the fuse terminal mating portion of the pressure welding terminal, which establishes an electrical connection between the joint terminal and the pressure welding terminal through a fusing portion of the fuse.

In the branch system of JP-A-9-63457, the fuse connector is completely fixed to the power supply line. Hence, it is difficult to freely move the fuse connector, for example, when the fuse needs to be replaced, when the state of the fuse needs to be checked, and when peripheral equipment including the fuse undergoes maintenance. Therefore, there is a problem that the work cannot be smoothly conducted. Moreover, the fuse that is used for the fuse connector has specifications unique to the branch system. There are also other problems that the fuse is often difficult to obtain and that the cost tends to increase.

### SUMMARY

A branch system according to an embodiment of the present disclosure includes a power connector attachable to a power supply line; and a branch connector attachable to a branch wire and connectable to the power connector in an attachable and detachable manner, in which the branch connector includes a glass tube fuse, and a first holding portion; the first holding portion is configured to hold the glass tube fuse in an attachable and detachable manner or in a fixed state; and the power supply line and the branch wire are configured to establish an electrical connection through a fusing portion of the glass tube fuse held by the first holding portion upon the branch connector being connected to the power connector.

### BRIEF DESCRIPTION OF THE DRAWINGS

FIG. 1 is a perspective view of a branch system according to one preferred embodiment of the present disclosure, and is a diagram illustrating a state where a branch connector and a relay connector are connected to a power connector;

FIG. 2 is a perspective view of the branch system according to the one preferred embodiment of the present disclosure, and is a diagram illustrating a state where the branch connector and the relay connector are disconnected from the power connector;

FIG. 3 is a perspective view of the power connector as viewed from above;

FIG. 4 is a perspective view of the power connector as viewed from a bottom side;

FIG. 5 is a front view of the power connector;

FIG. 6 is a bottom view of the power connector;

FIG. 7 is a rear perspective view illustrating the power connector and a board separately;

FIG. 8 is a front perspective view of the relay connector;

FIG. 9 is a front perspective view of the branch connector, and is a diagram illustrating a state where a holder member and a connector member are connected;

FIG. 10 is a bottom perspective view of the relay connector, and is a diagram illustrating the state where the holder member and the connector member are connected;

FIG. 11 is a front perspective view of the branch connector, and is a diagram illustrating a state where the holder member and the connector member are disconnected;

FIG. 12 is a rear perspective view of the branch connector, and is a diagram illustrating the state where the holder member and the connector member are disconnected; and

FIG. 13 is a bottom perspective view of the branch connector, and is a diagram illustrating the state where the holder member and the connector member are disconnected.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One of objects of the present disclosure is to provide, for example, a branch system that solves problems of the known technology such as described above.

A branch system according one aspect of the present disclosure includes a power connector attachable to a power supply line; and a branch connector attachable to a branch wire and connectable to the power connector in an attachable and detachable manner, in which the branch connector includes a glass tube fuse, and a first holding portion; the first holding portion is configured to hold the glass tube fuse in an attachable and detachable manner or in a fixed state; and the power supply line and the branch wire are configured to establish an electrical connection through a fusing portion of the glass tube fuse held by the first holding portion upon the branch connector being connected to the power connector.

According to the branch system of the present disclosure, the fuse is provided not to the power connector that is attached to the power supply line, but to the branch connector that can be connected to the power connector in an attachable and detachable manner and is attached to the branch wire. Hence, it is easy to conduct work such as the replacement and checking of the fuse and the maintenance of peripheral equipment. Moreover, according to the branch system of the present disclosure, an inexpensive commercial glass tube fuse that is easy to obtain can be used.

According to the present disclosure, it is possible to provide a branch system on which it is easy to conduct work such as the replacement and checking of a fuse and the maintenance of peripheral equipment and which can use an inexpensive commercial glass tube fuse that is readily available.

An illustrative embodiment for carrying out the present disclosure will be described in detail hereinafter with reference to the drawings. A preferred embodiment is described below. However, the present disclosure is not limited by the embodiment described below. Note that terms such as “top surface,” “up-and-down direction,” “horizontal direction,” “horizontal,” and “bottom surface” described in the specification are terms used to simply represent relative directions, and do not limit the orientation of the system, for example, when in use.

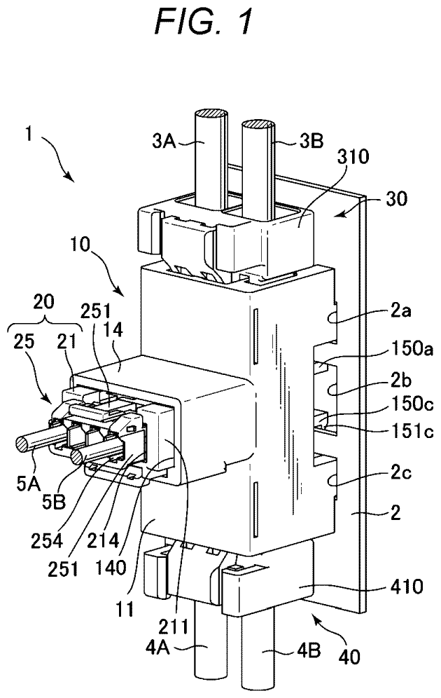

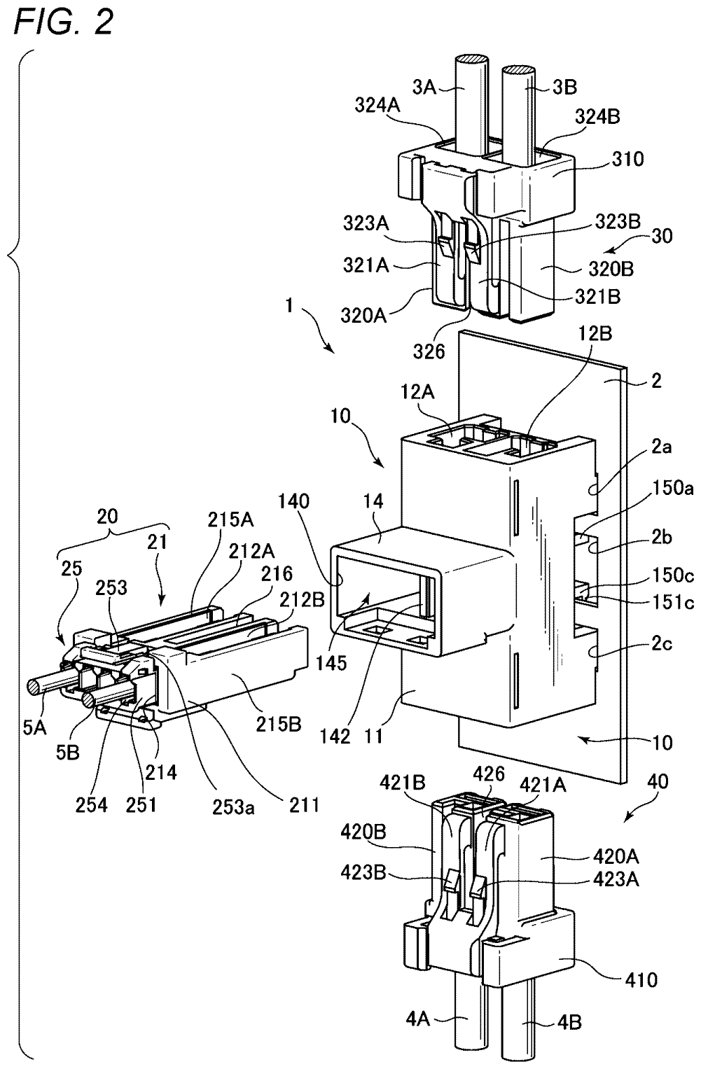

Perspective views of FIGS. 1 and 2 illustrate a state of a branch system according to one preferred embodiment of the present disclosure in use. The branch system is mainly used for a direct current power supply.

A branch system 1 includes a power connector 10, and a branch connector 20 that can be connected to the power connector 10 in an attachable and detachable manner. The branch system 1 can also further include relay connectors 30 and 40 that can be connected to the power connector 10 in an attachable and detachable manner. The power connector 10 can also be used in a fixed state.

FIG. 1 illustrates a state where the power connector 10 fixed to a board 2 being an attached member is connected to the branch connector 20 and the relay connectors 30 and 40. FIG. 2 illustrates a state where the branch connector 20 and the relay connectors 30 and 40 are disconnected from the power connector 10.

Note that in the embodiment, the relay connector 30 and the relay connector 40 have totally the same size and structure. Hence, in the following description, only the relay connector 30 is mainly described in detail, and the detailed description of the relay connector 40 is omitted except when necessary. Moreover, reference numerals for the relay connector 40 use corresponding reference numerals in the “400 range” instead of reference numerals in the “300 range” for the relay connector 30. For example, a reference numeral “310” and a reference numeral “410” denote the same member.

A power supply line 3A and a ground line 3B, and a power supply line 4A and a ground line 4B can be attached to the power connector 10. In the embodiment, the power supply line 3A and the ground line 3B use the relay connector 30, and the power supply line 4A and the ground line 4B use the relay connector 40, and the power supply line 3A and the ground line 3B, and the power supply line 4A and the ground line 4B are each attached indirectly to the power connector 10. Although not particularly illustrated, the power supply line 3A and the ground line 3B, and the power supply line 4A and the ground line 4B may each be attached directly to the power connector 10 without using the relay connector 30 and the relay connector 40.

The relay connector 30 and the relay connector 40 may be commercial products such as presented in the embodiment. The power supply line 3A and the ground line 3B can be attached directly to the relay connector 30. The power supply line 4A and the ground line 4B can be attached directly to the relay connector 40. The use of the relay connectors 30 and 40 allows the power supply line 3A and the ground line 3B, and the power supply line 4A and the ground line 4B to be attached to the power connector 10 indirectly and in an attachable and detachable state. The relay connectors 30 and 40 are connected to the power connector 10 to connect the power supply line 3A to the power supply line 4A and connect the ground line 3B to the ground line 4B.

Branch wires 5A and 5B can be attached to the branch connector 20. The branch connector 20 is connected to the power connector 10 with the relay connectors 30 and 40 being connected to the power connector 10. Consequently, the power supply lines 3A and 4A and the branch wire 5A are electrically connected. As a result, currents through the power supply lines 3A and 4A can be branched to the branch connector 20. Moreover, at this point in time, the ground lines 3B and 4B and the branch wire 5B are also similarly electrically connected. As a result, a ground function is provided to the branch connector 20.

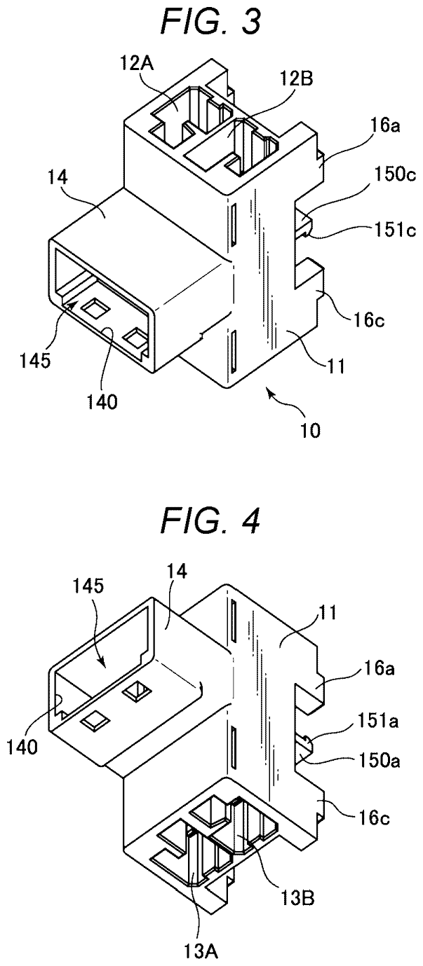

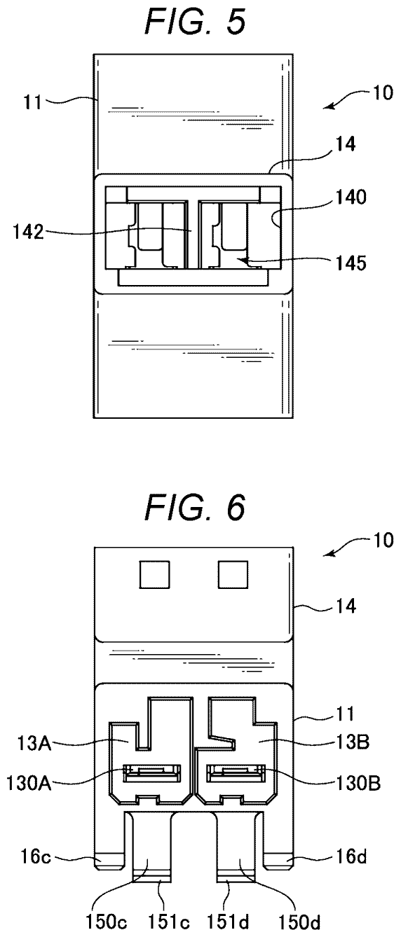

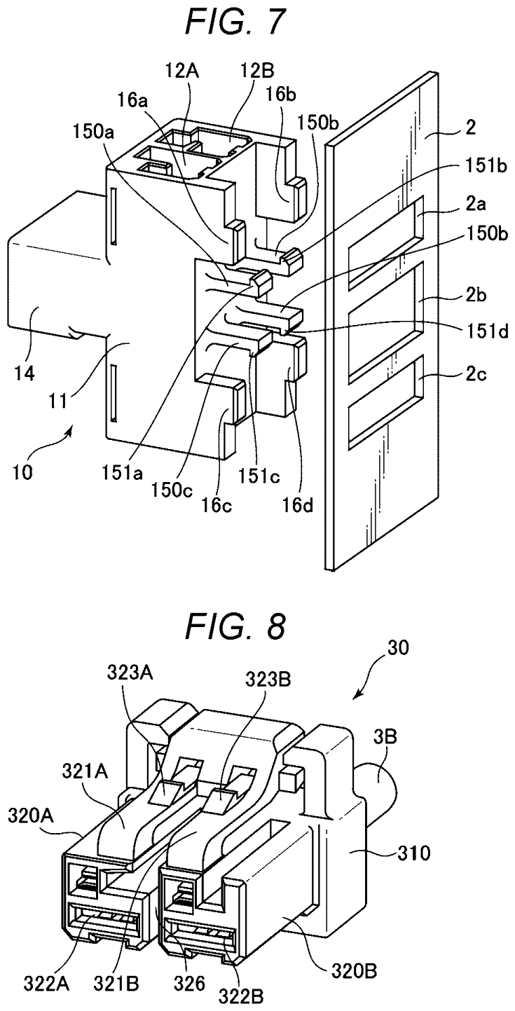

The power connector 10 will be described in more detail with reference to FIGS. 3 to 7 in addition to FIGS. 1 and 2. FIG. 3 is a perspective view of the power connector 10 as viewed from above. FIG. 4 is a perspective view of the power connector 10 as viewed from a bottom side. FIG. 5 is a front view of the power connector 10. FIG. 6 is a bottom view of the power connector 10. FIG. 7 is a rear perspective view illustrating the power connector 10 and the board 2 separately.

A top surface of a main body 11 of the power connector 10 is provided with insertion holes 12A and 12B. Predetermined portions (attached portions 320A and 320B; refer to FIG. 8) of the relay connector 30 are inserted into the insertion holes 12A and 12B, respectively, when the relay connector 30 is attached to the power connector 10. Moreover, a bottom surface of the main body 11 of the power connector 10 is provided with insertion holes 13A and 13B. Predetermined portions (attached portions 420B and 420A) of the relay connector 40 are inserted into the insertion holes 13A and 13B, respectively, when the relay connector 40 is attached to the power connector 10. The power connector 10 has a bilaterally symmetrical shape in a width direction except these insertion holes 12A, 12B, 13A, and 13B and their peripheral structure. The width direction is a left-and-right direction in the front view of FIG. 5.

A front side of the main body 11 of the power connector 10 is provided with a rectangular tubular attaching portion 14. The attaching portion 14 protrudes from the main body 11 toward a branch connector 20 attaching side. The attaching portion 14 includes an attaching space 145 and an attaching opening 140. The attaching portion 14 is configured in such a manner that part of the branch connector 20 is housed in the attaching space 145 through the attaching opening 140.

A back side of the main body 11 of the power connector 10 is provided with fixing means for fixing the power connector 10 to the board 2. The fixing means include positioning projections 16a, 16b, 16c, and 16d, and elastic locking pieces 150a, 150b, 150c, and 150d. Corresponding to these fixing means of the power connector 10, the board 2 is provided with three rectangular through-holes 2a, 2b, and 2c. The through-holes 2a, 2b, and 2c are arranged in this order from top to bottom in a vertical direction. The middle through-hole 2b is slightly larger than the through-holes 2a and 2c that are placed above and below the through-hole 2b, respectively. The through-holes 2a and 2c have the same size. The positioning projections 16a to 16d are used to position the power connector 10 in the through-holes 2a and 2c. The elastic locking pieces 150a to 150d are used to lock the power connector 10 in the through-hole 2b (refer to FIG. 7).

The positioning projections 16a and 16b are provided at a position corresponding to the through-hole 2a, in a state of protruding horizontally from the main body 11 toward the through-hole 2a, and has a slightly smaller dimension in the vertical direction than the through-hole 2a. Similarly, the positioning projections 16c and 16d are provided at a position corresponding to the through-hole 2c, in a state of protruding horizontally from the main body 11 toward the through-hole 2c, and has a slightly smaller dimension in the vertical direction than the through-hole 2c. In this manner, the positioning projections 16a to 16d are inserted into the through-hole 2a and the through-hole 2c to enable the power connector 10 to be positioned in a predetermined place on the board 2.

The elastic locking pieces 150a and 150b are provided at a position corresponding to an upper side of the through-hole 2b, in a state of protruding horizontally from the main body 11 toward the through-hole 2b. The elastic locking pieces 150c and 150d are provided at a position corresponding to a lower side of the through-hole 2b, in a state of protruding horizontally from the main body 11 toward the through-hole 2b. Distal ends of the elastic locking pieces 150a and 150b are provided with locking portions 151a and 151b protruding upward, respectively. Distal ends of the elastic locking pieces 150c and 150d are provided with locking portions 151c and 151d protruding downward, respectively.

When the positioning projections 16a and 16b are inserted into the through-hole 2a, and the positioning projections 16c and 16d are inserted into the through-hole 2c, the locking portions 151a to 151d of the elastic locking pieces 150a to 150d are caught on the upper and lower sides of the through-hole 2b. Consequently, the power connector 10 can be locked to the board 2.

Next, the configuration of the relay connector 30 will be described in detail with reference to FIG. 8 in addition to FIGS. 1 and 2. FIG. 8 illustrates a front perspective view of the relay connector 30.

In the following description, one side of a base portion 310 of the relay connector 30 is a side, to which the power supply line 3A and the ground line 3B are attached, of the relay connector 30, and the other side is a side, which is mated to the power connector 10, of the relay connector 30.

The one side of the base portion 310 of the relay connector 30 is provided with an attaching hole 324A for attaching the power supply line 3A, and an attaching hole 324B for attaching the ground line 3B (refer to FIG. 2). Moreover, the other side of the base portion 310 of the relay connector 30 is provided with two attached portions 320A and 320B extending parallel to each other across a groove 326 and in a length direction of the relay connector 30. These attached portion 320A and attached portion 320B have different shapes in cross section to prevent wrong mating. The attached portion 320A is used to connect the power supply line 3A to the power connector 10. The attached portion 320B is used to connect the ground line 3B to the power connector 10.

Distal ends of the attached portions 320A and 320B are provided with insertion slots 322A and 322B, respectively. When the relay connector 30 is connected to the power connector 10, these attached portions 320A and 320B are inserted into the insertion holes 12A and 12B of the power connector 10, respectively. At this point in time, protruding portions (not illustrated) that are provided to distal end portions of the insertion holes 12A and 12B respectively are inserted into the insertion slots 322A and 322B of the attached portions 320A and 320B. As a result, the power supply line 3A and the ground line 3B are electrically connected to terminals (not illustrated) provided inside the power connector 10, respectively. Note that the bottom view of FIG. 6 illustrates protruding portions 130A and 130B that are provided to distal end portions of the insertion holes 13A and 13B of the power connector 10, respectively. The protruding portions of the insertion holes 12A and 12B have the same structures as the protruding portions 130A and 130B of the insertion holes 13A and 13B.

The attached portions 320A and 320B are each provided with an elastic piece 321A including a locking projection 323A, and an elastic piece 321B including a locking projection 323B. When the attached portions 320A and 320B are inserted into the insertion holes 12A and 12B of the power connector 10, respectively, the locking projection 323A and the locking projection 323B are locked to predetermined portions provided inside the insertion holes 12A and 12B, respectively; therefore, the relay connector 30 is fixed to the power connector 10.

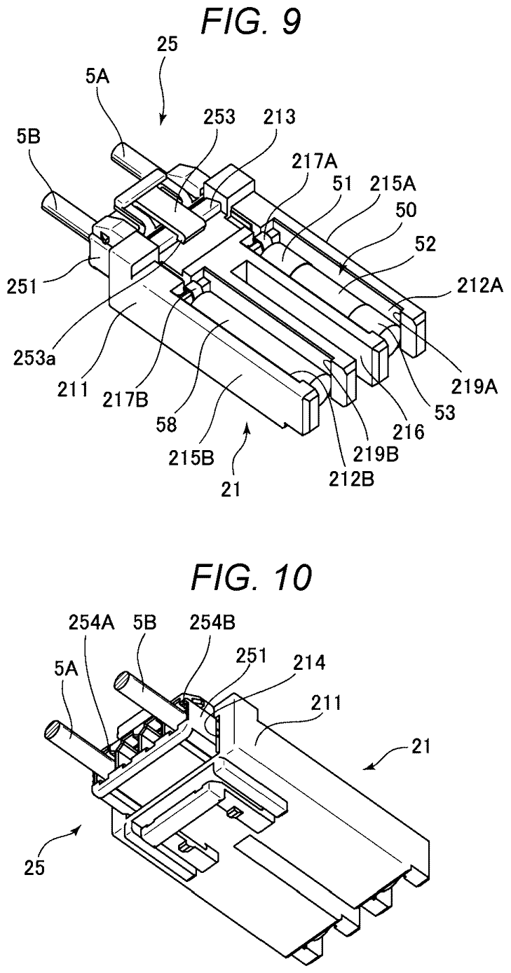

The branch connector 20 will be described in more detail with reference to FIGS. 9 to 13 in addition to FIGS. 1 and 2. The branch connector 20 of the embodiment includes a holder member 21, and a connector member 25 that can be connected to the holder member 21 in an attachable and detachable manner. Each of the holder member 21 and the connector member 25 has a bilaterally symmetrical shape in the width direction.

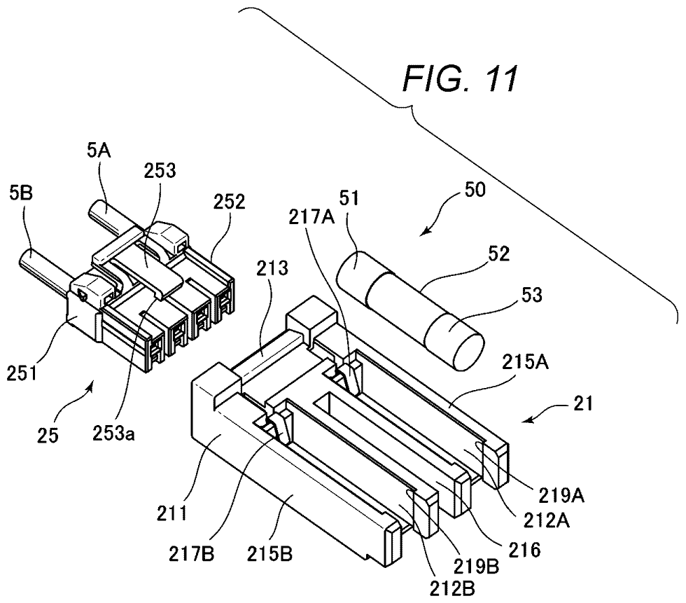

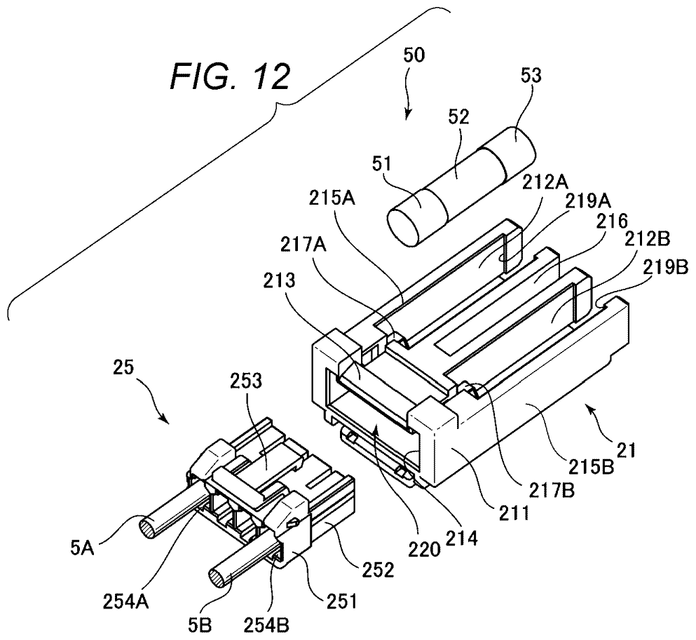

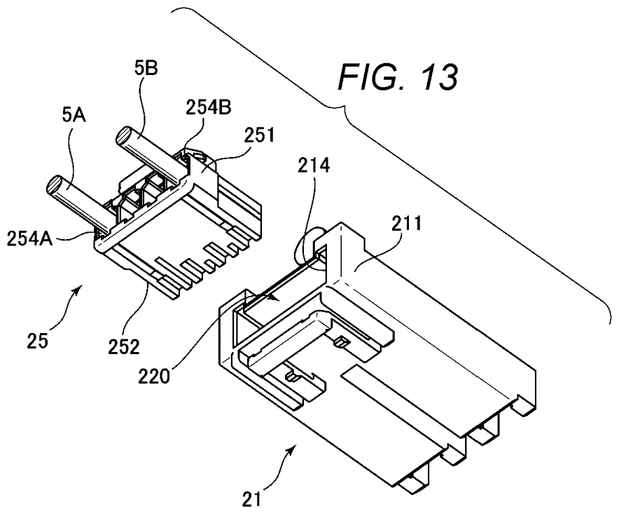

FIGS. 9 and 10 illustrates a state where the holder member 21 and the connector member 25 are connected as in FIG. 1. FIG. 9 illustrates a front perspective view of the branch connector 20 in the connected state. FIG. 10 illustrates a bottom perspective view. FIGS. 11 to 13 illustrate a state where the holder member 21 and the connector member 25 are disconnected, unlike FIG. 1. FIG. 11 illustrates a front perspective view of the disconnected branch connector 20. FIG. 12 illustrates a rear perspective view. FIG. 13 illustrates a bottom perspective view.

In the following description, one side of a base portion 251 of the connector member 25 is a side, to which the branch wire 5A and the branch wire 5B are attached, of the connector member 25, and the other side is a side, which is mated to the holder member 21, of the connector member 25.

The branch wire 5A and the branch wire 5B can be attached to the connector member 25. The one side of the base portion 251 of the connector member 25 is provided with an attaching hole 254A for attaching the branch wire 5A, and an attaching hole 254B for attaching the branch wire 5B. Moreover, the other side of the base portion 251 of the connector member 25 is provided with a mated portion 252 extending horizontally. Terminals (not illustrated) that can come into electrical contact with the branch wires 5A and 5B respectively are provided inside the mated portion 252.

In the following description, one side of a base portion 211 of the holder member 21 is a side, which is mated to the connector member 25, of the holder member 21, and the other side of the base portion 211 of the holder member 21 is a side, which is connected to the power connector 10, of the holder member 21.

The one side of the base portion 211 of the holder member 21 is provided with a mating space 220, to which the mated portion 252 of the connector member 25 is mated, corresponding to the connector member 25. When the connector member 25 is connected to the holder member 21, the mated portion 252 of the connector member 25 is fitted into the mating space 220 through an attaching opening 214. When the mated portion 252 is housed in the mating space 220, the branch wires 5A and 5B come into contact with and establish electrical connections with relay terminals 217A and 217B provided to the holder member 21, through electrical contacts with the terminals provided inside the mated portion 252. The connector member 25 locks a locking projection 253a of an elastic piece 253 extending from the base portion 251 to a locked portion 213 provided on the one side of the base portion 211 of the holder member 21, and therefore, is fixed to the holder member 21.

The other side of the base portion 211 of the holder member 21 is provided with a holding portion 212A and a holding portion 212B. The holding portion 212A is provided in such a manner as to be capable of holding a glass tube fuse 50 in an attachable and detachable manner. The holding portion 212B is provided in such a manner as to be capable of holding a conductive member 58 in an attachable and detachable manner. These holding portions 212A and 212B extend from the base portion 211 parallel to each other and in a length direction of the holder member 21.

One end side (a connector member 25 mating side) of the holding portion 212A is provided with the relay terminal 217A, and the other end side (a power connector 10 mating side) of the holding portion 212A is provided with a pair of support walls 219A. Similarly, one end side (a connector member 25 mating side) of the holding portion 212B is provided with the relay terminal 217B, and the other end side (a power connector 10 mating side) of the holding portion 212B is provided with a pair of support walls 219B.

Moreover, each of the holding portions 212A and 212B has a recessed shape in cross section, and its cross section includes a pair of approximately plate-shaped members 215A and 215B. Each of the pairs of approximately plate-shaped members 215A and 215B includes plate-shaped bodies that face each other and extend parallel in the length direction of the holder member 21.

The pair of support walls 219A is provided to distal ends of the plate-shaped bodies of the approximately plate-shaped members 215A and 215B of the holding portion 212A, and protrudes from the plate-shaped bodies toward each other in a width direction of the holder member 21, respectively. Similarly, the pair of support walls 219B is provided to distal ends of the plate-shaped bodies of the approximately plate-shaped members 215A and 215B of the holding portion 212B, and protrudes from the plate-shaped bodies toward each other in the width direction of the holder member 21, respectively.

The glass tube fuse 50 includes a fuse holder 51, a main body 52, and a fuse holder 53. One end of the main body 52 is connected to the fuse holder 51, and the other end is connected to the fuse holder 53. The main body 52 is provided with a fusing portion that is blown by overcurrent.

When the glass tube fuse 50 is held by the holding portion 212A, one end (the fuse holder 51) of the glass tube fuse 50 is elastically supported by the relay terminal 217A, and the other end (the fuse holder 53) of the glass tube fuse 50 is fixed and supported by the pair of support walls 219A.

Similarly, when the conductive member 58 is held by the holding portion 212B, one end of the conductive member 58 (an end portion on a connector member 25 mating side of the conductive member 58) is elastically supported by the relay terminal 217B, and the other end of the conductive member 58 (an end portion on a power connector 10 mating side of the conductive member 58) is fixed and supported by the pair of support walls 219B.

Upper portions of these holding portions 212A and 212B are open. Hence, a user can easily mount and dismount the glass tube 50 in and from the holding portion 212A, and can easily mount and dismount the conductive member 58 in and from the holding portion 212B. In other words, the user can easily access, from the outside, the glass tube 50 held by the holding portion 212A and the conductive member 58 held by the holding portion 212B.

Moreover, the upper portions of the holding portions 212A and 212B are open; therefore, it is also possible to easily and visually check the states of the glass tube fuse 50 and the conductive member 58, particularly the state of the fusing portion of the glass tube fuse 50, from the outside even after the glass tube fuse 50 and the conductive member 58 are held by the holding portions 212A and 212B.

Furthermore, in this configuration, the glass tube fuse 50 and the conductive member 58 are provided to the holder member 21 of the branch connector 20 that is configured in such a manner as to be attachable to and detachable from the power connector 10. Hence, the user can easily conduct work such as the replacement, checking, and maintenance of the glass tube fuse 50, for example, in a state where only the branch connector 20 removed from the power connector 10 is moved to the user's hand, without moving the power connector 10 attached to, for example, the power supply line 3A. Furthermore, in this configuration, an inexpensive commercial glass tube fuse is used; therefore, it is possible to significantly reduce, for example, the product cost and the maintenance cost.

A groove 216 is provided between the holding portions 212A and 212B of the holder member 21. A partition wall 142 (refer to FIGS. 2 and 5) corresponding to the groove 216 is provided in the attaching space 145 of the attaching portion 14 of the power connector 10.

When the branch connector 20 is connected to the power connector 10, the holding portion 212A, the holding portion 212B, and the base portion 211 of the branch connector 20 are housed in the attaching space 145 of the power connector 10 with the partition wall 142 placed in the groove 216.

When the branch connector 20 is connected to the power connector 10, the glass tube fuse 50 held by the holding portion 212A comes into electrical contact at the fuse holder 51 with the relay terminal 217A of the holder member 21, and comes into electrical contact at the fuse holder 53 with the terminal provided inside the power connector 10. As a result, the glass tube fuse 50 can establish an electrical connection between the power supply line 3A and the branch wire 5A through the fusing portion provided inside the main body 52 of the glass tube fuse 50 on the basis of the above contacts.

Note that the fusing portion is a fusible fuse-element, and is configured in such a manner as to be blown when a current exceeding a predetermined value (an overcurrent) flows. The fusing portion is a conductor having a predetermined resistance value in an unfused state.

Similarly, when the branch connector 20 is connected to the power connector 10, the conductive member 58 held by the holding portion 212B comes into electrical contact with the relay terminal 217B provided to the holder member 21 at the end portion on the connector member 25 mating side, and comes into electrical contact with the terminal provided inside the power connector 10 at the end portion on the power connector 10 mating side. As a result, the conductive member 58 can establish an electrical connection between the ground line 3B and the branch wire 5B on the basis of the above contacts.

With the above configuration, even when an overcurrent flows between the power supply line 3A and the branch wire 5A, the fusing portion of the glass tube fuse 50 is blown. Therefore, it is possible to reduce the influence of the overcurrent on equipment. Moreover, as described above, the space above the glass tube fuse 50 held by the holding portion 212A is open; therefore, it is possible to easily and visually check whether or not the fusing portion is blown, from the outside. Furthermore, even if a housing of the branch connector 20 is damaged by, for example, an overcurrent flowing between the power supply line 3A and the branch wire 5A, it is possible to reduce influence on the connector member 25 attached to the holder member 21, and as a result, it is also possible to obtain an effect of continuously using the connector member 25 by replacing only the holder member 21.

Note that the present disclosure is not limited to the above-mentioned embodiment, and can be modified in various manners.

For example, in the above-mentioned embodiment, the power supply line 3A and the ground line 3B are attached indirectly to the power connector 10 by use of, for example, the relay connector 30. However, the power supply line 3A and the ground line 3B may be attached directly to the power connector 10 without using, for example, the relay connector 30. Moreover, in the above-mentioned embodiment, the branch wires 5A and 5B are attached directly to the connector member 25. However, the branch wires 5A and 5B may be attached indirectly to the connector member 25 by use of, for example, the relay connector 30.

Moreover, the holding portions 212A and 212B of the holder member 21 have the same size and shape. Therefore, when the glass tube fuse 50 and the conductive member 58 are made to have, for example, the same size, it is also possible to cause the holding portion 212B to hold the glass tube fuse 50 and cause the holding portion 212A to hold the conductive member 58.

The branch connector 20 may not include two components of the holder member 21 and the connector member 25, and may be formed as a single component as long as it can hold the glass tube fuse 50.

Furthermore, the glass tube fuse 50 and the conductive member 58 may not be provided to the holding portions 212A and 212B in an attachable and detachable manner, but may be provided the holding portions 212A and 212B in a fixed state.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A branch system comprising:
a power connector attachable to a power supply line; and
a branch connector attachable to a branch wire and connectable to the power connector in an attachable and detachable manner, wherein
the branch connector includes a glass tube fuse, and a first holding portion,
the first holding portion is configured to hold the glass tube fuse in an attachable and detachable manner or in a fixed state, and
the power supply line and the branch wire are configured to establish an electrical connection through a fusing portion of the glass tube fuse held by the first holding portion upon the branch connector being connected to the power connector.

2. The branch system according to claim 1, wherein
the branch connector further includes a conductive member and a second holding portion,
the second holding portion is configured to hold the conductive member in an attachable and detachable manner or in a fixed state, and
the power supply line and the branch wire are configured to establish an electrical connection through the conductive member held by the second holding portion upon the branch connector being connected to the power connector.

3. The branch system according to claim 1, further comprising a relay connector, wherein
the relay connector is configured to be attachable to the power supply line and connectable to the power connector in an attachable and detachable manner, and
the power connector includes an insertion hole into which the relay connector is insertable.

4. The branch system according to claim 1, wherein
the branch connector includes a holder member and a connector member,
the holder member includes the first holding portion,
the connector member is configured to be attachable to the branch wire and connectable to the holder member in an attachable and detachable manner, and
the power supply line and the branch wire are configured to establish an electrical connection through the fusing portion of the glass tube fuse held by the first holding portion upon the branch connector including the holder member and the connector member being connected to the power connector.

5. The branch system according to claim 4, wherein
the holder member further includes a conductive member and a second holding portion,
the second holding portion is configured to hold the conductive member in an attachable and detachable manner or in a fixed state, and
the power supply line and the branch wire are configured to establish an electrical connection through the conductive member held by the second holding portion upon the branch connector including the holder member and the connector member being connected to the power connector.

6. The branch system according to claim 1, wherein the first holding portion holds at least part of the fusing portion of the glass tube fuse in a state of being visible from outside.

7. The branch system according to claim 1, wherein the first holding portion holds the glass tube fuse in an attachable and detachable manner in a state of being accessible from the outside.

8. The holder member according to claim 4.
